(19) United States
(12) Patent Application Publication
(10) Pub. No.: US 2009/0000855 A1
(43) Pub. Date: Jan. 1, 2009

(54) POWER STEERING DEVICE

(75) Inventors: Toru HASEBE, Isesaki-shi (JP); Sosuke Sunaga, Higashimatsuyama-shi (JP); Masaki Watanabe, Higashimatsuyama-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/138,842

(22) Filed: Jun. 13, 2008

(30) Foreign Application Priority Data
Jun. 29, 2007 (JP) 2007-172169

(51) Int. Cl. B62D 5/06

(52) U.S. Cl. 180/421

(57) ABSTRACT

Right-turn and left-turn aimed input shaft drive mechanisms are provided, each comprising a piston unit that slides in a bore formed in an output shaft and a contact surface that is formed on an input shaft. Under normal cruising of a vehicle, a comfortable steering feeling is given by a relatively small counter torque that is produced by a contact between the piston unit and a second inclined surface of the contact surface, and upon stray running of the vehicle due to doze in driving or the like, a relatively large steering torque is produced by a contact between the piston unit and a first inclined surface of the contact surface. An inclination angle of the second inclined surface relative to a traveling path of the piston unit is greater than that of the first inclined surface.

### BACKGROUND OF THE INVENTION

1. Field of the Invention

The present invention relates in general to power steering devices that assist the driver to steer a motor vehicle with a hydraulic power, and more particularly to the power steering devices of an integral type that is commonly applied to a large-sized motor vehicle. More specifically, the present invention is concerned with power steering devices of a type that not only provides a driver with a satisfied steering feeling under normal cruising of the vehicle, but also assists an automatic returning of the vehicle to an original lane when the vehicle is subjected to a stray running due to doze in driving or the like.

2. Description of the Related Art

In order to clarify the present invention, the background of the above-mentioned type of the power steering devices will be briefly described in the following.

The power steering device of such type generally comprises an input shaft that is rotated by a steering wheel, an output shaft that is linked to steered road wheels, a torsion bar that operatively connects the input and output shafts, a power cylinder that produces an assist power when hydraulically energized, a hydraulic pump that feeds the power cylinder with a pressurized fluid for energizing the same, and a rotary switch valve that is arranged between the input and output shafts to switch fluid passages provided between the power cylinder and the hydraulic pump. That is, by switching the fluid passages in accordance with a turning direction of the steering wheel (viz., input shaft), a piston of the power cylinder is enforcedly moved in a desired direction to assist a steered movement of the steered road wheels.

In the power steering device shown in Japanese Laid-open Patent Application (Tokkaihei) 3-258658, there is employed a counter-torque mechanism that causes the driver to feel a certain resistance when he or she turns the steering wheel. That is, when the driver turns the steering wheel in one direction, the counter-torque mechanism produces a force (viz., counter-torque) in a reversed direction by practically using the hydraulic pressure fed from the hydraulic pump.

The counter-torque mechanism disclosed by the above-mentioned Laid-open Patent Application comprises a recess of V-shaped cross section that is formed in the input shaft, a plunger that is connected to the output shaft, and a ball that is held by the plunger and placed on the recess of the input shaft. The plunger is arranged to bias the ball against the input shaft. That is, when, due to turning of the steering wheel by the driver, a relative rotation occurs between the input and output shafts, the center of the ball and that of the recess become offset in a circumferential direction of the input and output shafts. Under this condition, the plunger is operated to press the ball against an inclined wall of the V-shaped recess of the input shaft with the aid of the hydraulic pressure fed from the hydraulic pump, so that the input shaft is applied with a counter torque caused by a pressed contact between the ball and the inclined wall of the recess. The counter torque is transmitted to the driver's hands through the steering wheel, which causes him or her to feel the certain resistance comfortably.

### SUMMARY OF THE INVENTION

The above-mentioned power steering device of Japanese Laid-open Patent Application exhibits a satisfied performance in producing a certain resistance that is felt by the driver when he or she turns the steering wheel for steering the motor vehicle. Such resistance is important for safely driving the motor vehicle.

However, for the safety driving of the vehicle, other functions are also needed, one of which may be a function to automatically return the vehicle to a previous or original lane once the vehicle has made a stray running due to doze in driving or the like.

One method for establishing such automatic returning of the motor vehicle to the original lane is to modify the counter-torque mechanism of the power steering device of the above-mentioned Japanese Laid-open Patent Application. In the method, the modification may be so made that the above-mentioned offset connection between the center of the ball and the center of the recess is made in a neutral condition of the rotary switch valve where the torsion bar is free of torsion. That is, when it is detected that the vehicle makes a stray running due to doze in driving or the like, a certain operation is applied to the counter-torque mechanism for positively turning the rotary switch valve, which causes the power assist for steering the vehicle and assists the vehicle to automatically return to the previous or original lane.

However, due to its inherent construction, this method inevitably brings about an excessively high counter torque at the time of steering the motor vehicle under normal cruising of the vehicle, which of course deteriorates a steering feeling with which the driver operates the steering wheel.

Accordingly, it is an object of the present invention to provide a power steering device which is free of the above-mentioned drawback.

According to the present invention, there is provided a power steering device which not only exhibits a satisfied steering feeling under normal cruising of the vehicle, but also assists an automatic returning of the vehicle to the original lane in the above-mentioned emergency case.

In accordance with a first aspect of the present invention, there is provided a power steering device which comprises an input shaft (40) to which a steering wheel (SW) is connected; an output shaft (60) connected to the input shaft (40) through a torsion bar (50); a rotary switch valve (600) arranged between the input and output shafts (40, 60) for selectively feeding a pressurized hydraulic fluid from a hydraulic pump (P) to rightward-steering and leftward-steering assist chambers (21, 22) of a power cylinder in accordance with a relative rotation between the input and output shafts (40, 60); a right-turn aimed input shaft drive mechanism (200) that applies the input shaft (40) with a torque in a right-turn direction by using the pressurized hydraulic fluid from the hydraulic pump (P); a left-turn aimed input shaft drive mechanism (100) that applies the input shaft (40) with a torque in a left-turn direction by using the pressurized hydraulic fluid from the hydraulic pump (P); a detecting device (400) that detects a current condition of at least one of a vehicle on which the power steering device is mounted, a driver who drives the vehicle and a road on which the vehicle runs; and a liquid pressure control device (320, 310) that controls the pressure of the hydraulic fluid fed to the right-turn aimed and left-turn aimed input shaft drive mechanisms (200, 100) in accordance with the current condition detected by the detecting device (400), wherein the liquid pressure control device (320, 310) controls the two input shaft drive mechanisms (200, 100) in such a manner that upon steering operation by the driver, the input shaft (40) is applied with a counter torque in a direction against a steering direction of the input shaft (40), and upon receiving information signal from the detecting device (400), the input shaft (40) is applied with a steering torque by a degree sufficient for practically actuating the rotary switch valve (600), wherein each of the two input shaft drive mechanisms (200, 100) comprises a contact surface (43, 42) that is formed on an outer surface of the input shaft (40), and a piston unit (220, 120) that slides in a radially extending bore (210, 110) formed in the output shaft (60) and is able to press against the contact surface (43, 42) with the aid of the hydraulic pressure from the hydraulic pump (P), wherein the contact surface (43, 42) is inclined relative to a given path along which the piston unit (220, 120) travels, so that pressing the piston unit (220, 120) against the contact surface (43, 42) applies the input shaft (40) with the torque; and wherein an inclination angle of the contact surface (43, 42) relative to the given path changes at a portion where the piston unit (220, 120) changes a traveling direction.

In accordance with a second aspect of the present invention, there is provided a power steering device which comprises an input shaft (40) to which a steering wheel (SW) is connected; an output shaft (60) connected to the input shaft (40) through a torsion bar (50); a rotary switch valve (600) arranged between the input and output shafts (40, 60) for selectively feeding a pressurized hydraulic fluid from a hydraulic pump (P) to rightward-steering and leftward-steering assist chambers (21, 22) of a power cylinder in accordance with a relative rotation between the input and output shafts (40, 60); a right-turn aimed input shaft drive mechanism (200) that applies the input shaft (40) with a torque in a right-turn direction by using the pressurized hydraulic fluid from the hydraulic pump (P); a left-turn aimed input shaft drive mechanism (100) that applies the input shaft (40) with a torque in a left-turn direction by using the pressurized hydraulic fluid from the hydraulic pump (P); a detecting device (400) that detects a current condition of at least one of a vehicle on which the power steering device is mounted, a driver who drives the vehicle and a road on which the vehicle runs; and a liquid pressure control device (320, 310) that controls the pressure of the hydraulic fluid fed to the right-turn aimed and left-turn aimed input shaft drive mechanisms (200, 100) in accordance with the current condition detected by the detecting device (400), wherein the liquid pressure control device (320, 310) controls the two input shaft drive mechanisms (200, 100) in such a manner that upon steering operation by the driver, the input shaft (40) is applied with a counter torque in a direction against a steering direction of the input shaft (40), and upon receiving information signal from the detecting device (400), the input shaft (40) is applied with a steering torque by a degree sufficient for practically actuating the rotary switch valve (600), wherein each of the two input shaft drive mechanisms (200, 100) comprises a contact surface (43, 42) that is formed on an outer surface of the input shaft (40), and a piston unit (220, 120) that slides in a radially extending bore (210, 110) formed in the output shaft (60) and is able to press against the contact surface (43, 42) with the aid of the hydraulic pressure from the hydraulic pump (P), wherein the contact surface (43, 42) is inclined relative to a given path along which the piston unit (220, 120) travels and comprises a first inclined surface (43a, 42a) and a second inclined surface (43b, 42b) whose inclination angle is greater than that of the first inclined surface (43a, 42a), and wherein when the piston unit (220, 120) presses against the second inclined surface (43b, 42b), the input shaft (40) is applied with the counter torque, and when the piston unit (220, 120) presses against the first inclined surface (43a, 42a), the input shaft (40) is applied with the steering torque.

In accordance with a third aspect of the present invention, there is provided a power steering device which comprises an input shaft (40) to which a steering wheel (SW) is connected; an output shaft (60) connected to the input shaft (40) through a torsion bar (50); a rotary switch valve (600) arranged between the input and output shafts (40, 60) for selectively feeding a pressurized hydraulic fluid from a hydraulic pump (P) to rightward-steering and leftward-steering assist chambers (21, 22) of a power cylinder in accordance with a relative rotation between the input and output shafts (40, 60); a right-turn aimed input shaft drive mechanism (200) that applies the input shaft (40) with a torque in a right-turn direction by using the pressurized hydraulic fluid from the hydraulic pump (P); a left-turn aimed input shaft drive mechanism (100) that applies the input shaft (40) with a torque in a left-turn direction by using the pressurized hydraulic fluid from the hydraulic pump (P); a detecting device (400) that detects a current condition of at least one of a vehicle on which the power steering device is mounted, a driver who drives the vehicle and a road on which the vehicle runs; and a liquid pressure control device (320, 310) that controls the pressure of the hydraulic fluid fed to the right-turn aimed and left-turn aimed input shaft drive mechanisms (200, 100) in accordance with the current condition detected by the detecting device (400), wherein the liquid pressure control device (320, 310) controls the two input shaft drive mechanisms (200, 100) in such a manner that upon steering operation by the driver, the input shaft (40) is applied with a counter torque in a direction against a steering direction of the input shaft (40), and upon receiving information signal from the detecting device (400), the input shaft (40) is applied with a steering torque by a degree sufficient for practically actuating the rotary switch valve (600), wherein each of the two input shaft drive mechanisms (200, 100) comprises a contact surface (43, 42) that is formed on an outer surface of the input shaft (40), and a piston unit (220, 120) that slides in a radially extending bore (210, 110) formed in the output shaft (60) and is able to press against the contact surface (43, 42) with the aid of the hydraulic pressure from the hydraulic pump (P), wherein the contact surface (43, 42) comprises a first inclined surface (43a, 42a) against which the piston unit (220, 120) presses when the same (220, 120) moves toward the input shaft (40) and a second inclined surface (43b, 42b) against which the piston unit (220, 120) presses when the same (220, 120) moves away from the input shaft (40), the inclination angle of the second inclined surface (43b, 42b) being greater than that of the first inclined surface (43a, 42a).

### BRIEF DESCRIPTION OF THE DRAWINGS

Other objects and advantages of the present invention will become apparent from the following description when taken in conjunction with the accompanying drawings, in which:

FIG. 1 is a block diagram of a power steering device of a first embodiment of the present invention;

FIG. 2 is an axially sectional view of the power steering device of the first embodiment;

FIG. 3 is an enlarged sectional view taken along the line A-A of FIG. 2;

FIG. 4 is an enlarged sectional view taken along the line B-B of FIG. 2;

FIG. 5 is an enlarged sectional view taken along the line C-C of FIG. 2;

FIG. 6 is an enlarged view of a part of FIG. 4 showing a condition wherein a right-turn aimed piston unit and a right-turn aimed contact surface contact;

FIG. 7 is an enlarged view of an area indicated by an arrow “P” of FIG. 6;

FIG. 8 is an illustration showing a behavior of a right-turn aimed input shaft drive mechanism, which is induced when a relative rotation occurs between input and output shafts;

FIG. 9 is a graph showing a performance of first and second embodiments of the present invention and a comparative example, in terms of a relationship between an open degree of a rotary switch valve (R.S.V.) and a distance between a line of action and an axis of the input shaft;

FIG. 10 is a view similar to FIG. 6, but showing an arrangement of the comparative example;

FIG. 11 is an enlarged view of a part of FIG. 4, but showing a condition wherein the right-turn aimed input shaft drive mechanism rotates the rotary switch valve;

FIG. 12 is a view similar to FIG. 7, but showing a first modification of the first embodiment;

FIG. 13 is a view similar to FIG. 7, but showing a second modification of the first embodiment;

FIG. 14 is a view similar to FIG. 6, but showing a third modification of the first embodiment; and

FIG. 15 is a view similar to FIG. 6, but showing a second embodiment of the present invention.

### DETAILED DESCRIPTION OF THE INVENTION

In the following, a power steering device of the present invention will be described in detail with reference to the accompanying drawings.

For ease of explanation, the following description will include various directional terms, such as, right, left, upper, lower, rightward and the like. However, such terms are to be understood with respect to only a drawing or drawings on which a corresponding portion or part is shown.

The power steering device of the present invention is explained as being practically applied to a large-sized motor vehicle, such as truck or the like.

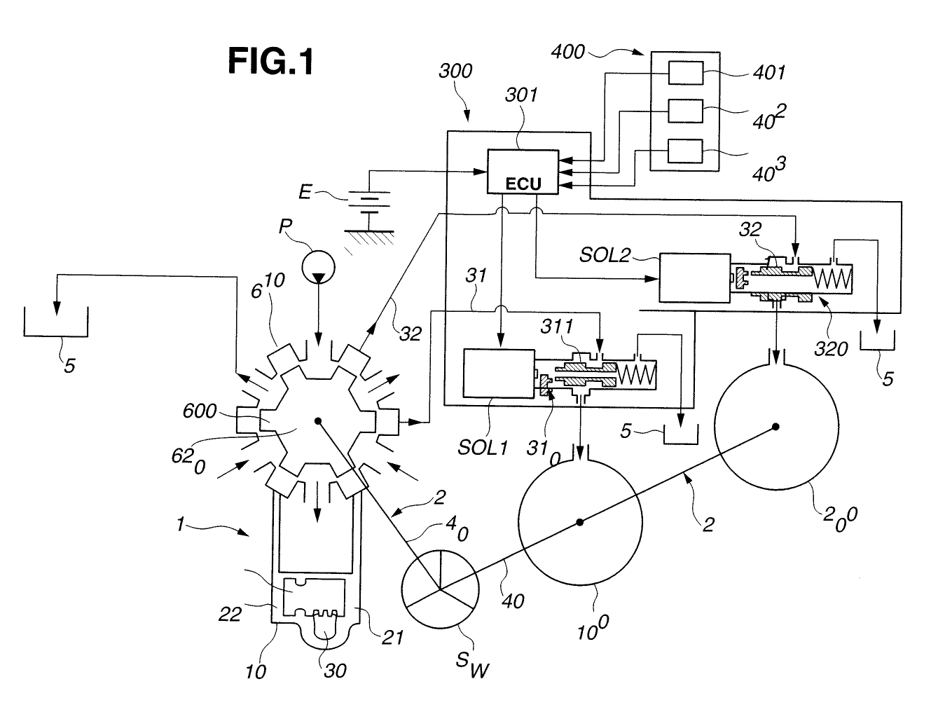

Referring to FIG. 1, there is shown a block diagram of a power steering device 1 of a first embodiment of the present invention.

As shown in the drawing, power steering device 1 comprises a steering shaft 2 that is connected to a steering wheel SW to turn therewith, a rotary switch valve 600 that functions to switch or change the direction of power-assist, an assist-aimed piston 70 that is installed in a hydraulic power cylinder 10 to produce an assist force with the aid of a hydraulic pressure, and a sector shaft 30 that is meshed with assist-aimed piston 70 so that forward-and-backward movement of assist-aimed piston 70 includes rightward (or clockwise) and leftward (or counterclockwise) turning of sector shaft 30. Although not shown in the drawing, sector shaft 30 is linked to steered road wheels of an associated motor vehicle, so that the turning of sector shaft 30 induces powered right or left turning of the steered road wheels.

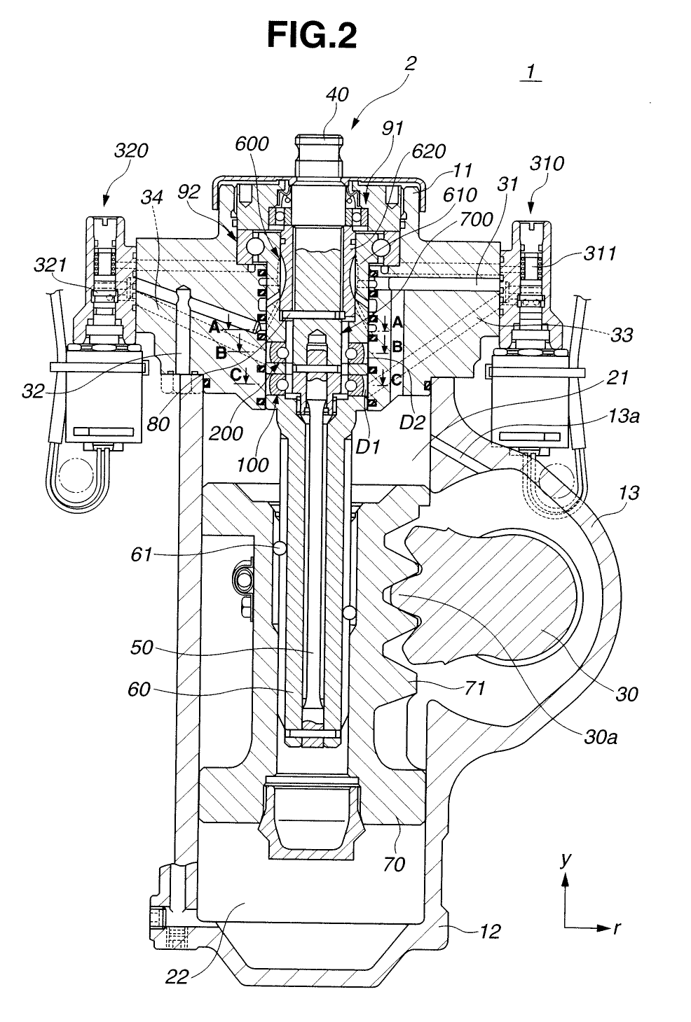

As is best seen from FIG. 2, steering shaft 2 comprises an input shaft 40, an output shaft 60 and a torsion bar 50 that operatively connects input and output shafts 40 and 60.

As is seen from FIGS. 1 and 2, power steering device 1 further comprises a left-turn aimed input shaft drive mechanism 100 that functions to apply input shaft 40 with a left-turn aimed counter-torque with the aid of hydraulic pressure, a right-turn aimed input shaft drive mechanism 200 that functions to apply input shaft 40 with a right-turn aimed counter-torque with the aid of hydraulic pressure, and a hydraulic pressure control part 300 that controls a hydraulic pressure fed to the left-turn aimed input shaft drive mechanism 100 and the right-turn aimed input shaft drive mechanism 200.

As is seen from FIG. 1, when steering wheel SW is turned in one or other direction, the hydraulic fluid from a hydraulic pump P is led into one of working chambers 21 and 22 of hydraulic power cylinder 10 through a fluid passage selected by rotary switch valve 600.

For ease of understanding, these working chambers 21 and 22 will be referred to as rightward-steering assist chamber and leftward-steering assist chamber in the following description.

As shown, these two assist chambers 21 and 22 are arranged to bias or push the assist-aimed piston 70 in leftward and rightward directions respectively when fed with the pressurized hydraulic fluid. Due to the leftward or rightward movement of the piston 70, center shaft 30 is turned counterclockwise or clockwise in FIG. 1, which steers the steered road wheels of the vehicle in a desired direction. As shown, a surplus of the hydraulic fluid is led into a reservoir tank 5 through rotary switch valve 600.

The left-turn aimed input shaft drive mechanism 100 and right-turn aimed input shaft drive mechanism 200 are of a hydraulic actuator that applies input shaft 40 with a left-turn aimed torque or right-turn aimed torque with the aid of a hydraulic power.

Under normal steering of the vehicle, these hydraulic actuators 100 and 200 serve as a counter-torque producing device that produces a counter-torque that is applied to input shaft 40 for providing a driver with a comfortable steering feeling.

While, when the vehicle is subjected to a stray running due to doze in driving or the like, that is, when a so-called automatic vehicle returning back to the original lane is needed, the hydraulic actuators 100 and 200 serve as a steering actuator means that turns input shaft 40 by a degree sufficient for turning rotary switch valve 600 to make a steering assist in a direction in which the torque is applied.

Hydraulic pressure control part 300 comprises a control unit 301, a left-turn aimed control valve 310 and right-turn aimed control valve 320. Control unit 301 is connected to a battery E and fed with information signals from a vehicle condition detecting part 400. That is, by processing such information signals, control unit 301 controls both left-turn aimed control valve 310 and right-turn aimed control valve 320.

Left-turn and right-turn aimed control valves 310 and 320 are connected to rotary switch valve 600 through respective fluid passages 31 and 32 for receiving the pressurized hydraulic fluid from hydraulic pump P. That is, when input shaft 40 is turned in a right or clockwise direction relative to output shaft 60, the pressurized hydraulic fluid from the pump P is led to left-turn aimed control valve 310, while when input shaft 40 is turned in a left or counterclockwise direction relative to output shaft 60, the pressurized hydraulic fluid is led into right-turn aimed control valve 320. During this operation, a surplus of the hydraulic fluid is led to reservoir tank 5.

Vehicle condition detecting part 400 comprises a vehicle speed sensor 401 that senses a speed of the associated motor vehicle, a first camera 402 that recognizes a white line on a lane, and a second cameral 403 that recognizes a driver's line of sight. By processing information signals from vehicle speed sensor 401 and first and second cameras 402 and 403, control unit 301 issues instruction signals by which both left-turn aimed control valve 310 and right-turn aimed control valve 320 are controlled.

Left-turn aimed control valve 310 comprises a left-turn aimed solenoid SOL1 and a left-turn aimed spool 311, and like the valve 310, right-turn aimed control valve 320 comprises a right-turn aimed solenoid SOL2 and a right-turn aimed spool 321. That is, in accordance with the instruction signals from control unit 301, ON/OFF condition of solenoids SOL1 and SOL2 is controlled and thus shifting of spools 311 and 321 is controlled. With the shifting of spools 311 and 321, the pressure of hydraulic fluid fed to left-turn aimed input shaft drive mechanism 100 and right-turn aimed input shaft drive mechanism 200 is controlled.

Referring to FIG. 2, there is shown the power steering device 1 in an axially sectional fashion.

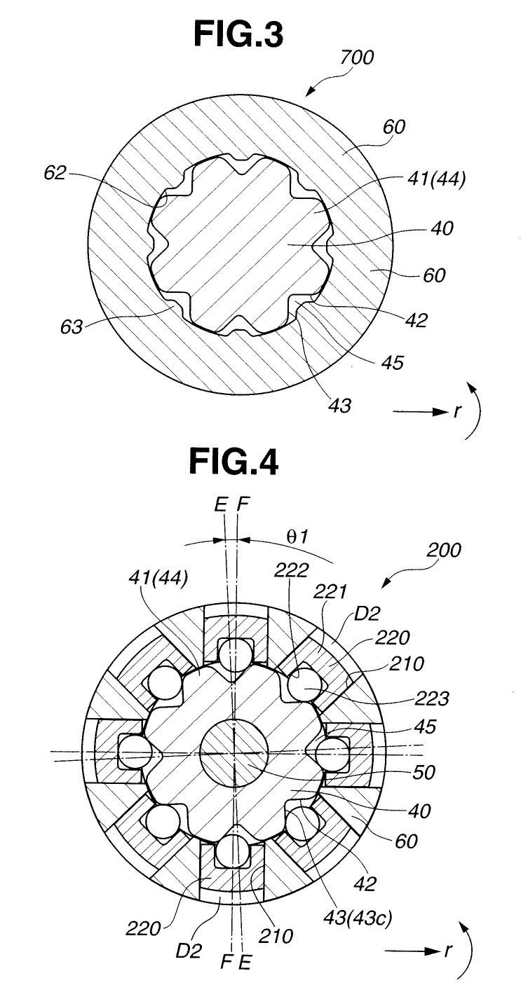

For ease of explanation, the axial direction of input and output shafts 40 and 60 will be defined as “y-axis”, and the side where input shaft 40 is positioned will be defined as positive side, and a polar coordinate will be defined about “y-axis” and a radial direction will be defined as “r-axis”. When, as is shown in FIG. 3, input and output shafts 40 and 60 are turned in a right or clockwise direction, it should be understood that the shafts 40 and 60 make “positive turning”.

As is shown in FIG. 2, rotary switch valve 600 is housed in a first housing 11, and assist-aimed piston 70 is housed in a second housing 12.

First and second housings 11 and 12 are each in the form of a cup and coaxially coupled to constitute a united housing. As shown, into an axially base portion of first housing 11, there is inserted input shaft 40 that is connected to steering wheel SW (see FIG. 1). Input shaft 40 is coaxially connected to output shaft 60 through torsion bar 50. As shown, output shaft 60 is a hollow member. Into a positive side of the hollow in y-axis direction, there is inserted input shaft 40, and into a negative side of the hollow in y-axis direction, there is inserted torsion bar 50. That is, due to provision of torsion bar 50 between input and output shafts 40 and 60, any torque applied to input shaft 40 from left-turn aimed or right-turn aimed input shaft drive mechanism 100 or 200 is suitably absorbed by torsion bar 50 that exhibits a certain resiliency, and thus, the steered road wheels (not shown) are suppressed from being affected by such torque. As shown, input and output shafts 40 and 60 are rotatably held by first and second bearings 91 and 92 that are held in first housing 11.

As is seen from FIG. 2, in second housing 12, there is axially movably arranged the assist-aimed piston 70. Due to provision of piston 70, the above-mentioned rightward-steering and leftward-steering assist chambers 21 and 22 are defined in second housing 12 at both sides of piston 70. When rightward-steering assist chamber 21 is fed with a pressurized hydraulic fluid, assist-aimed piston 70 is moved downward in FIG. 2, that is, in a direction to assist a rightward steering of the steered road wheels. While, when the other working chamber, viz., leftward-steering assist chamber 22 is fed with the hydraulic fluid, piton 70 is moved upward in FIG. 2, that is, in a direction to assist a leftward steering of the steered road wheels.

In a sector shaft housing part 13 formed on a cylindrical side of second housing 12, there is installed the above-mentioned sector shaft 30. As shown, sector shaft 30 extends perpendicular to the axis of second housing 12.

As shown in FIG. 2, output shaft 60 is inserted into an axial bore formed in assist-aimed piston 70 and engaged with the piston 70 through a ball-screw mechanism 61. On an outer surface of piston 70, there is formed a tooth portion 71 that extends in a circumferential direction of piston 70. Operatively engaged with tooth portion 71 is a sector gear 30a of the above-mentioned sector shaft 30.

As shown, the interior of sector shaft housing part 13 is communicated with rightward-steering assist chamber 21 through a fluid passage 13a, so that the hydraulic fluid in the chamber 21 enters the interior of housing part 13 for lubricating the meshed engagement between tooth portion 71 of piston 70 and sector gear 30a of sector shaft 30.

As will be easily understood from FIG. 1, rotary switch valve 600 functions to change a fluid inlet/outlet operation to and from rightward-steering and leftward-steering assist chambers 21 and 22 in accordance with a relative rotation between input and output shafts 40 and 60. For this operation, rotary switch valve 600 is formed with a plurality of inlet and outlet openings.

As is seen from FIG. 2, rotary switch valve 600 comprises generally a valve body 610 that is formed by output shaft 60 at an upper portion that surrounds input shaft 40, and a cylindrical rotor 620 that is coaxially received in a cylindrical space between the upper portion of output shaft 60 and input shaft 40 and tightly fixed to input shaft 40 through a connecting pin 80.

Rotary switch valve 600 is connected to rightward-steering assist chamber 21 through a fluid passage 31, so that when cylindrical rotor 620 turns in a right or clockwise direction (when viewed from the top of input shaft 40) relative to valve body 610, the pressurized hydraulic fluid from hydraulic pump P is led to rightward-steering assist chamber 21. Rotary switch valve 600 is also connected to leftward-steering assist chamber 21 through another fluid passage 32, so that when cylindrical rotor 620 turns in a left or counterclockwise direction (when viewed from the top of input shaft 40) relative to valve body 610, the hydraulic fluid from hydraulic pump P is led to leftward-steering assist chamber 22. In other words, when input shaft 40 is turned in a right direction relative to output shaft 60, rotary switch valve 600 functions to connect hydraulic pump P and rightward-steering assist chamber 21, while, when input shaft 40 is turned in a left direction relative to output shaft 60, rotary switch valve 600 functions to connect hydraulic pump P and leftward-steering assist chamber 22.

At a portion of negative side in the “y-axis” of rotary switch valve 600 where input and output shafts 40 and 60 are axially overlapped, there are arranged in parallel a fuel-safe device 700 as well as left-turn aimed and right-turn aimed input shaft drive mechanisms 100 and 200.

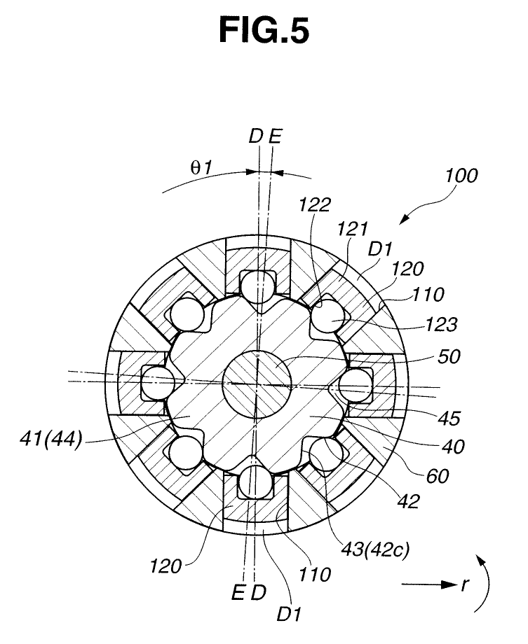

Referring to FIGS. 3 to 5, there are shown enlarged sectional views that are taken along the lines A-A, B-B and C-C of FIG. 2 respectively. That is, FIG. 4 shows a part of right-turn aimed input shaft drive mechanism 200 and FIG. 5 shows a part of left-turn aimed input shaft drive mechanism 100. It is to be noted that the sectional views of the drawings (viz., FIGS. 3 to 5) show a condition that is taken when rotary switch valve 600 is in its neutral position.

As is seen from these drawings, an outer cylindrical wall of input shaft 40, that constitutes part of fuel-safe device 700, part of left-turn aimed input shaft drive mechanism 100 and part of right-turn aimed input shaft drive mechanism 200, has thereabout serrations 41, and an inner cylindrical wall of output shaft 60, that constitutes part of fuel-safe device 700, has thereabout other serrations 62. These two types of serrations 41 and 62 are operatively engaged to constitute the fail-safe device 700.

As is seen from FIG. 3, external teeth 44 of input shaft serrations 41 and internal teeth 63 of output shaft serrations 62 are respectively and operatively engaged, so that a relative rotation between input and output shafts 40 and 60 is permitted by a given small degree. That is, excessive relative rotation is not permitted for preventing torsion bar 50 from being excessively twisted.

As is seen from FIG. 4, output shaft 60 is formed, at a cylindrical wall portion that constitutes right-turn aimed input shaft drive mechanism 200, with eight piston bores 210 which are equally spaced around the axis of output shaft 60, and as is seen from FIG. 5, output shaft 60 is formed, at another cylindrical wall portion that constitutes left-turn aimed input shaft drive mechanism 100, with eight piston bores 110 that are equally spaced around the axis of output shaft 60. As is seen from these drawings, each piston bore 210 or 110 operatively receives therein a piston unit 220 or 120.

That is, right-turn aimed input shaft drive mechanism 200 comprises eight piston bores 210 and eight piston units 220 respectively received in piston bores 210. While, left-turn aimed input shaft drive mechanism 100 comprises eight piston bores 110 and eight piston units 120 respectively received in piston bores 110.

As is seen from FIG. 5, at a radially outer side of each piston bore 110 that bounds on a radially outer end of the corresponding piston unit 120, there is defined a left-turn aimed torque production chamber D1, and as is seen from FIG. 4, at a radially outer side of each piston bore 210 that bounds on a radially outer end of the corresponding piston unit 220, there is defined a right-turn aimed torque production chamber D2.

As is seen from FIGS. 5 and 2, left-turn aimed torque production chamber D1 is communicated with the above-mentioned rightward-steering assist chamber 21 through left-turn aimed control valve 310 and fluid passages 31 and 33, and as is seen from FIGS. 4 and 2, right-turn aimed torque production chamber D2 is communicated with the above-mentioned leftward-steering assist chamber 22 through right-turn aimed control valve 320 and fluid passages 32 and 34.

With the arrangement as mentioned hereinabove, the hydraulic pressure in rightward-steering assist chamber 21 is controlled by control valve 310 before being fed to left-turn aimed input shaft drive mechanism 100, and like this, the hydraulic pressure in leftward-steering assist chamber 22 is controlled by control valve 320 before being fed to right-turn aimed input shaft drive mechanism 200.

As is seen from FIG. 5, when rotary switch valve 600 is in a neutral position, each piston bore 110 of left-turn aimed input shaft drive mechanism 100 takes an offset position in a rotation direction relative to a corresponding tooth space 45 of serration 41 of input shaft 40, and like this, as is seen from FIG. 4, each piston bore 210 of right-turn aimed input shaft drive mechanism 200 also takes an offset position in a rotation direction relative to a corresponding tooth space 45 of serration 41 of input shaft 40.

That is, as is seen from FIG. 5, an axis “D-D” of each piston bore 110 is offset by an angle “θ1” in a left-handed rotation direction relative to a center line “E-E” of the corresponding tooth space 45, and as is seen from FIG. 4, an axis “F-F” of each piston bore 210 is offset by an angle “θ1” in a right-handed rotation direction relative to the center line “E-E” of the tooth space 45.

It is thus to be noted that in a neutral condition of rotary switch valve 600, the above-mentioned axes “D-D” and “F-F” are displaced or offset by 2×“θ1”.

As is seen from FIGS. 4 and 5, each piston unit 220 or 120 comprises a piston body 221 or 121 that has at an inside end thereof (viz., at a radially inside end in the r-axis direction) a cylindrical recess 222 or 122, and a ball 223 or 123 that is received in cylindrical recess 222 or 122. It is to be noted that a diameter of ball 223 or 123 is slightly smaller than a diameter of cylindrical recess 222 or 122 for achieving a smoothed rotation or movement of ball 223 or 123 in the corresponding recess 222 or 122 under operation of the power steering device.

As is seen from FIGS. 4 and 5, each ball 223 or 123 has a part facing or projecting toward input shaft 40, so that upon existence of hydraulic pressure in torque production chamber D2 or D1, each ball 223 or 123 is moved in the radially inward in the r-axis direction. Upon this, each ball 223 or 123 is pressed against an inclined wall of serration 41 of input shaft 40, as is shown in the drawings.

That is, as is seen from FIG. 4, upon existence of pressure in torque production chamber D2, right-turn aimed piston unit 220 presses input shaft 40 in such a manner that the ball 223 presses a right-turn aimed contact surface 43 that is positioned nearer to the axis “F-F” than the center line “E-E”. While, as is seen from FIG. 5, upon existence of pressure in torque production chamber D1, the left-turn aimed piston unit 120 presses input shaft 40 in such a manner that the ball 123 presses a left-turn aimed contact surface 42 that is positioned nearer to the axis “D-D” than the center line “E-E”.

As has mentioned hereinabove, the relative rotation between input and output shafts 40 and 60 is restricted with a certain permissible rotation therebetween. Thus, as is seen from FIG. 4, pressing the right-turn aimed piston unit 220 against the right-turn aimed contact surface 43 applies a certain torque to input shaft 40 in a right or clockwise direction, which causes turning of input shaft 40 in right or clockwise direction. While, as is seen from FIG. 5, pressing the left-turn aimed piston unit 120 against left-turn aimed contact surface 42 applies a certain torque to input shaft 40 in left or counterclockwise direction, which causes turning of input shaft 40 in left or counterclockwise direction.

The above-mentioned explanation on the contact between ball 223 or 123 and inclined wall 43 or 42 of each serration 41 will be much clarified from the following description.

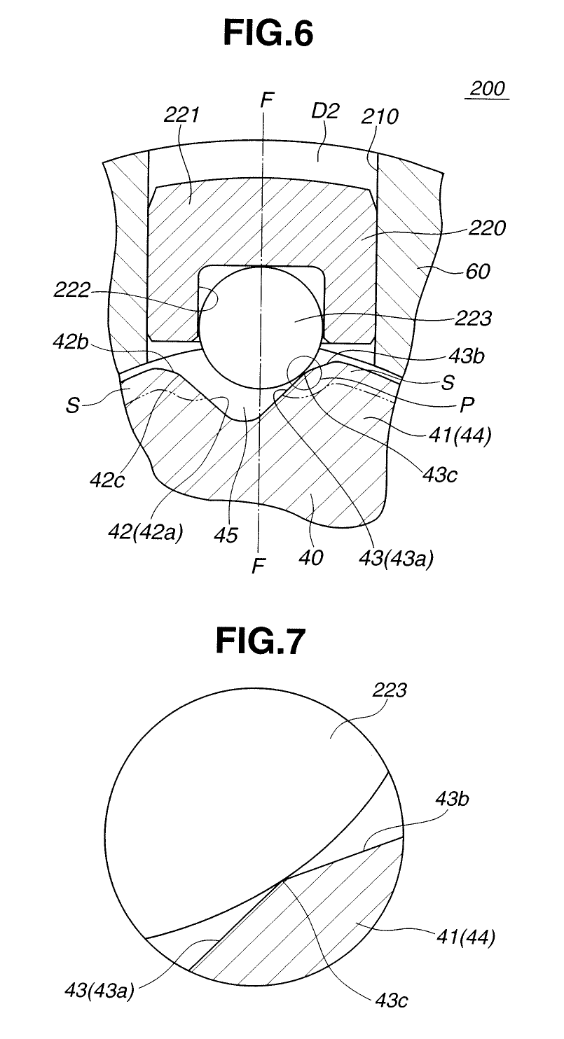

FIG. 6 is an enlarged view of a part of FIG. 4 where right-turn aimed input shaft drive mechanism 200 is provided, that is, where right-turn aimed piston unit 220 presses right-turn aimed contact surface 43 through ball 223.

FIG. 7 is an enlarged view of a part “P” shown in FIG. 6.

As will be understood from FIGS. 6 and 7, right-turn aimed contact surface 43 for the right-turn aimed input shaft drive mechanism 200 comprises a first inclined surface 43a that is positioned away from right-turned aimed piston unit 220 and inclined to the axis “F-F” of piston bore 210 by a first angle, a second inclined surface 43b that is positioned near right-turn aimed piston unit 220 and inclined to the axis “F-F” of piston bore 210 by a second angle that is larger than the first angle, and a corner part 43c that is provided between first and second inclined surfaces 43a and 43b. While, left-turn aimed contact surface 42 comprises a first inclined surface 42a that is positioned away from right-turn aimed piston unit 220 and inclined to the axis “F-F” of piston bore 210 by a first angle, a second inclined surface 42b that is positioned near right-turn aimed piston unit 220 and inclined to the axis “F-F” of piston bore 210 by a second angle that is larger than the first angle, and a corner portion 42c that is provided between first and second inclined surfaces 42a and 42b.

Like the above, as will be understood from FIG. 5, right-turn aimed contact surface 43 for the left-turn aimed input shaft drive mechanism 100 comprises a first inclined surface 43a that is positioned away from left-turn aimed piston unit 120 and inclined to the axis “D-D” of piston bore 110 by a first angle, a second inclined surface 42b that is positioned near left-turn aimed piston unit 120 and inclined to the axis “D-D” of piston bore 110 by a second angle that is larger than the first angle, and a corner part 42c that is provided between first and second inclined surfaces 42a and 42b. While, left-turn aimed contact surface 42 comprises a first inclined surface 42a that is positioned away from left-turn aimed piston unit 120 and inclined to the axis “D-D” of piston bore 110 by a first angle, a second inclined surface 42b that is positioned near left-turn aimed piston unit 120 and inclined to the axis “D-D” of piston bore 110 by a second angle that is larger than the first angle, and a corner part 42c that is provided between first and second inclined surfaces 42a and 42b.

It is now to be noted that when rotary switch valve 600 assumes a neutral position thereof, each ball 223 for right-turn aimed input shaft drive mechanism 200 is in contact with corner part 43c of right-turn aimed contact surface 43 as is seen from FIGS. 4 and 6, and at the same time each ball 123 for left-turn aimed input shaft drive mechanism 100 is in contact with corner 42c of left-turn aimed contact surface 42.

It is to be noted that input shaft 40 is made of a steel treated with a surface hardening process. As is seen from FIG. 6, each tooth space 45 of serration 41 of input shaft 40 has surface hardened areas S to which ball 223 (or 123) contacts. Due to provision of such surface hardened areas S, satisfied durability of input shaft 40 is obtained.

In the following, operation of the power steering device of the first embodiment will be described with the aid of the accompanying drawings, particularly FIGS. 1 and 2.

When steering wheel SW is turned in a left direction, that is, in a counterclockwise direction, input shaft 40 makes a certain left turning relative to output shaft 60 due to flexibility of torsion bar 50. Upon this, rotary switch valve 600 functions to feed the pressurized hydraulic fluid from hydraulic pump P to left-steering assist chamber 22 producing a certain pressure difference between two assist chambers 21 and 22. Accordingly, assist-aimed piston 70 is shifted upward in FIG. 2 (that is, in a positive direction in the Y-axis), and thus, the sector shaft 30 is turned in a clockwise direction in the drawing. With this clockwise turning of sector shaft 30, the leftward steering action effected by the steered road wheels is assisted.

During this operation, the hydraulic fluid in leftward-steering assist chamber 22 is led into right-turn aimed control valve 320 through fluid passage 32 and thus controlled in pressure by the valve 320 and then the pressure-controlled hydraulic fluid is led into the right-turn aimed torque production chambers D2 of right-turn aimed input shaft drive mechanism 200. With this, all of right-turn aimed piston units 220 press the corresponding balls 223 against right-turn aimed contact surfaces 43 (see FIG. 6) thereby to apply input shaft 40 with a certain torque in a rightward direction, that is, a counter torque against the leftward turning of steering wheel SW effected by the driver.

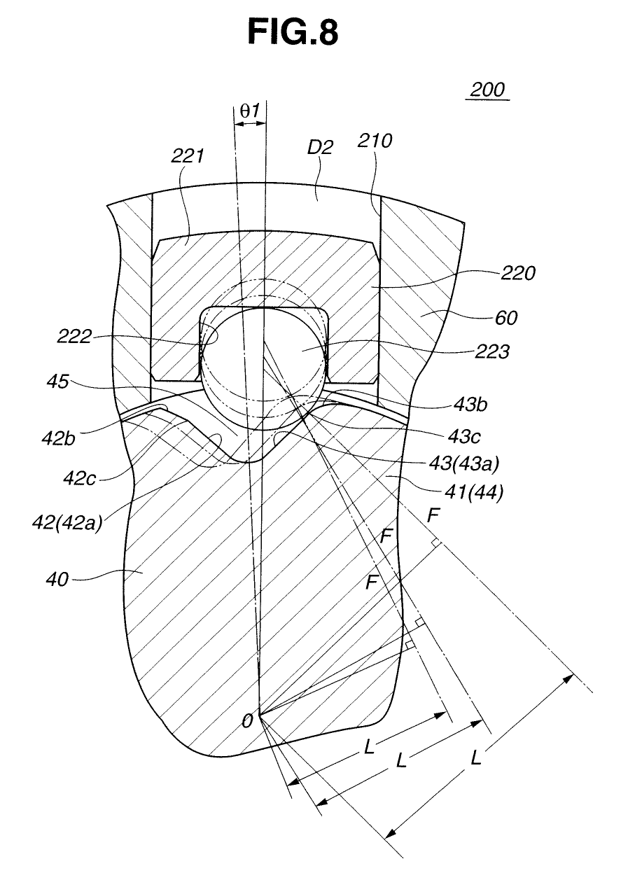

FIG. 8 is a sketch showing a change in relative position between right-turn aimed piston unit 220 and right-turn aimed contact surface 43 with respect to a position of the corresponding ball 223.

That is, when steering wheel SW is in a neutral position, rotary switch valve 600 also takes a neutral position. Under this condition, intake shaft 40 and ball 223 take positions indicated by solid lines in FIG. 8.

When, now, steering wheel SW is turned in a left or counterclockwise direction, input shaft 40 is turned leftward relative to output shaft 60 and thus takes a position indicated by a phantom line in FIG. 8 pushing up ball 223 upward. That is, when, due to the leftward turning of steering wheel SW, rotary switch valve 600 is turned leftward causing ball 223 to move backward together with right-turn aimed piston unit 220 keeping a sliding contact with right-turn aimed contact surface 43 and finally contacting with second inclined surface 43b as is understood from FIG. 8. Under this condition, right-turn aimed piston unit 220 presses second inclined surface 43b through ball 223, and thus, input shaft 40 is applied with the above-mentioned smaller counter torque.

As is seen from FIG. 8, during this, a distance “L” (which will be referred to as “imaginary arm length” hereinafter for ease of description) between an action line “F” (viz., line of action) along which right-turn aimed piston unit 220 (actually, ball 223) presses input shaft 40 and the axis “O” of input shaft 40 changes in accordance with the relative turning between input and output shafts 40 and 60.

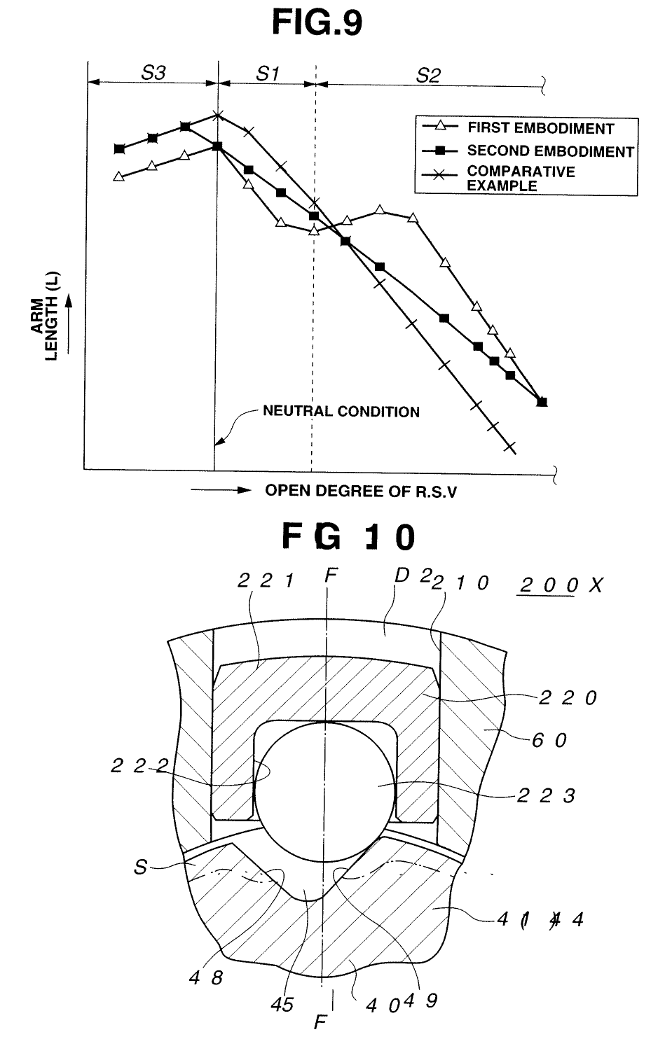

FIG. 9 is a graph showing a relationship between an open degree of rotary switch valve 600 and the imaginary arm length “L” of right-turn aimed input shaft drive mechanism 200 in case of the first embodiment, an after-mentioned second embodiment and a comparative example.

The comparative example is shown in FIG. 10, in which the pressuring receiving surfaces 48 and 49 for right-turn aimed input shaft drive mechanism 200X have no portions that correspond to the above-mentioned corner part. As shown, left-turn aimed contact surface 48 and right-turn aimed contact surface 49 are inclined at the same angle relative to the axis “F-F” of piston bore 210. Of course, in case of left-turn aimed input shaft drive mechanism (not shown), similar arrangement is employed between left-turn aimed contact surface and right-turn aimed receiving surface.

In the first embodiment, when it is intended to apply a counter torque to input shaft 40 by means of right-turn aimed input shaft drive mechanism 200, each right-turn aimed piston unit 220 presses second inclined surface 43b of the corresponding right-turn contact surface 43 through ball 223. As is seen from the graph of FIG. 9, in a first open range “S1” of rotary switch valve 600 wherein the open degree in a leftward steering direction is relatively small, the imaginary arm length “L” is smaller than that of the comparative example, which means that the counter torque produced in the first embodiment is smaller than that produced in the comparative example.

While, in a second open range “S2” of rotary switch valve 600 wherein the open degree in a leftward steering direction is relatively large, the imaginary arm length “L” is larger than that of the comparative example, which means that the counter torque produced in the first embodiment is larger than that of the comparative example. With this, undesirable over steering is suppressed.

While, in case of assisting a rightward steering, the hydraulic fluid in rightward-steering assist chamber 21 (see FIG. 2) is led into left-turn aimed torque production chambers D1 through hydraulic passages 31 and 33, so that left-turn aimed input shaft drive mechanism 100 applies input shaft 40 with a relatively small counter torque.

As has been mentioned hereinabove, when the hydraulic pressure in rightward-steering assist chamber 21 is higher than that in leftward-steering assist chamber 22, a counter torque is applied to input shaft 40 in a direction to turn the same in a leftward direction by left-turn aimed input shaft drive mechanism 100, while, when the hydraulic pressure in leftward-steering assist chamber 22 is higher than that in rightward-steering assist chamber 21, a counter torque is applied to input shaft 40 in a direction to turn the same in a rightward direction by right-turn aimed input shaft drive mechanism 200.

During the above-mentioned operation, left-turn aimed control valve 310 and right-turn aimed control valve 320 are controlled in accordance with a vehicle speed detected by vehicle speed sensor 401, so that the counter torque actually applied to input shaft 40 is controlled in accordance with the vehicle speed.

If a doze in driving or the like is detected by processing information signal from second camera 403, both control valves 310 and 320 are alternately actuated, so that the hydraulic pressure in left-turn aimed torque production chambers D1 and that in right-turn aimed torque production chambers D2 are alternately raised and lowered. With this operation, input shaft 40 is applied with a left-turn aimed steering torque and a right-turn aimed steering torque alternately, so that input shaft 40 is subjected to a vibration. In this case, steering wheel SW is also vibrated alarming the driver.

If a stray running of the vehicle is detected by processing information signals from first camera 402, both control valves 310 and 320 are suitably controlled with the aid of control unit 301, so that the fuel safe device 700 carries out a relative rotation between input and output shafts 40 and 60 to positively change the open degree of rotary switch valve 600 for automatically returning the vehicle to the original white line of the road.

This automatic returning of the vehicle to the original lane will be much clarified from the following description.

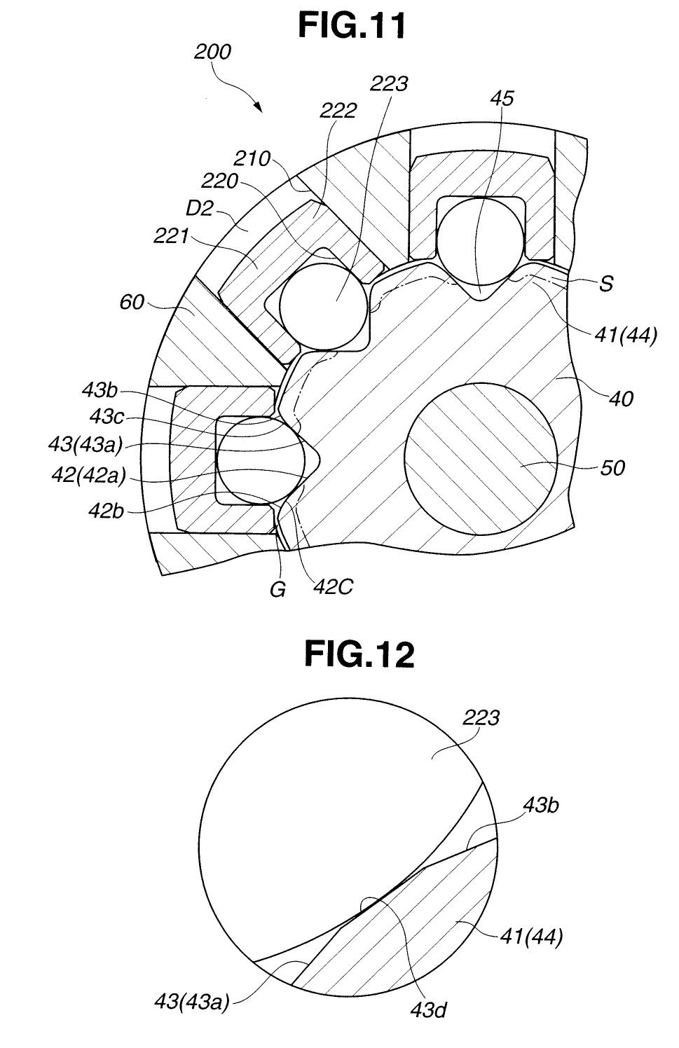

FIG. 11 is an enlarged view of a part of FIG. 4, showing a condition wherein right-turn aimed input drive part 200 rotates input shaft 40 sufficient for rotating rotary switch valve 600 in a right steering direction.

That is, when the vehicle makes a stray running in a leftward direction by the above-mentioned reason, right-turn aimed control valve 320 (see FIG. 2) is controlled to feed right-turn aimed torque production chambers D2 with a pressurized hydraulic fluid. With this, eight right-turn aimed piston units 220 are moved radially inward pressing balls 223 against inclined surfaces 42 and 43 of tooth spaces 45, thereby to apply input shaft 40 with a torque in a right turn direction. As is seen from FIG. 11, upon this, a certain clearance “G” is defined between an inward end of each piston unit 220 and a corresponding part of input shaft 40.

That is, due to the radially inward movement, each piston unit 220 of right-turn aimed input shaft drive mechanism 200 is brought into contact with first inclined surface 43a of the corresponding right-turn aimed contact surface 43 of input shaft 40. Due to this contact, input shaft 40 is applied with a relatively large rightward steering torque while adequately turning rotary switch valve 600 in a right steering direction. Thus, the hydraulic pressure in rightward-steering assist chamber 21 is increased thereby to produce a steering assist force for steering the vehicle in a rightward direction, which returns the vehicle back to the original lane.

As is seen from the graph of FIG. 9, at a third open range “S3” where rotary switch valve 600 is turned in a rightward-steering direction, the imaginary arm length “L” shows a satisfied value.

If the vehicle makes a stray running in a rightward direction, left-turn aimed control valve 310 (see FIG. 2) is controlled to feed left-turn aimed torque production chambers D1 with a pressurized hydraulic fluid. With this, left-turn aimed input shaft drive mechanism 100 is energized to apply input shaft 40 with a relatively large leftward steering torque while turning rotary switch valve 600 in a left steering direction. Thus, the vehicle is automatically returned back to the original lane.

As will be understood from the foregoing description, in this embodiment, under normal cruising of the vehicle, left-turn aimed piston units 120 of left-turn aimed input shaft drive mechanism 100 and right-turn aimed piston units 220 of right-turn aimed input shaft drive mechanism 200 are alternately moved to press against second inclined surfaces 42b and 43b of input shaft 40 in accordance with leftward and rightward steering actions effected by the driver through steering wheel SW. Thus, a certain counter torque is applied to input shaft 40 upon each steering action by the driver.

While, upon detecting a stray running of the vehicle, left-turn aimed piston units 120 of left-turn aimed input shaft drive mechanism 100 and right-turn aimed piston units 220 of right-turn aimed input shaft drive mechanism 200 are alternately moved to press against first inclined surfaces 42a and 43a of input shaft 40 in accordance with leftward and rightward straying of the vehicle from an original lane. The pressing of the piston units 120 and 220 against first inclined surfaces 42a and 43a induces a turning of input shaft 40 by a degree sufficient for turning or operating rotary switch valve 600. Thus, an adequate steering torque is produced by power steering device 1, which is applied to input shaft 40 and used for returning the vehicle back to the original lane.

That is, left-turn aimed input shaft drive mechanism 100 and right-turn aimed input shaft drive mechanism 200 have each a first mode wherein a relatively small counterforce (viz., counter torque) is applied to input shaft 40 upon each steering action by the drive through steering wheel SW and a second mode wherein a satisfied steering force is applied to input shaft 40 upon sensing a stray running of the vehicle. Due to provision of the first mode, the steering feeling is improved and due to provision of the second mode, automatic returning of the vehicle to the original lane is established upon sensing a stray running of the vehicle.

As is described hereinabove, left-turn aimed contact surface 42 of each of left-turn aimed input shaft drive mechanism 100 (see FIG. 5) and right-turn aimed input shaft drive mechanism 200 (see FIG. 4) comprises first inclined surface 42a, second inclined surface 42b and corner part 42c provided between first and second inclined surfaces 42a and 42b. While, right-turn aimed contact surface 43 of each of left-turn aimed input shaft drive mechanism 100 and right-turn aimed input shaft drive mechanism 200 comprises first inclined surface 43a, second inclined surface 43b and corner part 43c provided between first and second inclined surfaces 43a and 43b. When rotary switch valve 600 is in its neutral position, each left-turn aimed piston unit 120 (see FIG. 5) contacts corner part 42c of left-turn aimed contact surface 42, and at the same time each right-turn aimed piston unit 220 (see FIG. 4) contacts corner part 43c of right-turn aimed contact surface 43. Thus, contacting of left-turn or right-turn aimed piton unit 120 or 220 with first inclined surface 42a or 43a or second inclined surface 42b or 43b is instantly achieved upon need of such contacting, which improves the response of the input shaft drive mechanisms 100 and 200.

If desired, each of input shaft drive mechanisms 100 and 200 may be so set that when rotary switch valve 600 is in its neutral position, left-turn or right-turn aimed piston unit 120 or 220 is in contact with first inclined surface 42a or 43a. When this modification is employed, very small steering action, which would occur when the vehicle runs straightly, is suppressed from having a rattle feel because the piston unit 120 or 220 does not contact corner part 42c or 43c.

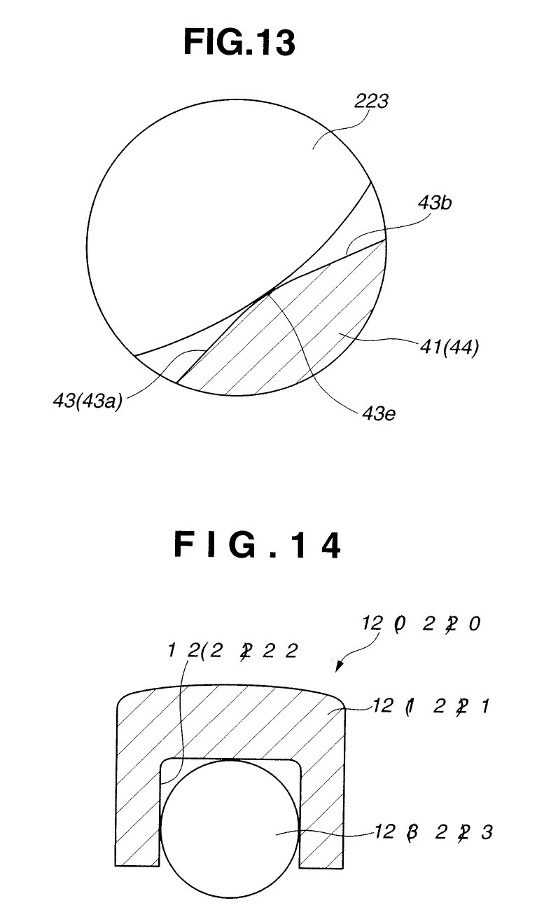

FIGS. 12 and 13 are enlarged views that show modifications of right-turn aimed contact surface 43 of the above-mentioned first embodiment. Actually, these drawings correspond to FIG. 7 and show a part of right-turn aimed input shaft drive mechanism 200. Although not shown in these drawings, in the modifications, left-turn aimed contact surface (42) has substantially same construction as the surface 43.

In the modification of FIG. 12, a chamfered flat surface 43d (or 42d) is provided between first inclined surface 43a (or 42a) and second inclined surface 43b (or 42b). Due to provision of such chambered flat surface 43d (or 42d), movement of right-turn aimed piston unit 220 (or left-turn aimed piston unit 120) to first inclined surface 43a (or 42a) or second inclined surface 43b (or 42b) is smoothly made when input and output shafts 40 and 60 make a relative rotation from the time when rotary switch valve 600 assumes the neutral position.

In the modification of FIG. 13, a chamfered round surface 43e (or 42e) is provided between first inclined surface 43a (or 42a) and second inclined surface 43b (or 42b). Due to provision of such chambered round surface 43e (or 42e), movement of right-turn aimed piston unit 220 (or left-turn aimed piston unit 120) to first inclined surface 43a (or 42a) or second inclined surface 43b (or 42b) is smoothly made when input and output shafts 40 and 60 make a relative rotation from the time when rotary switch valve 600 assumes the neutral position.

FIG. 14 is a view of a modification of left-turn and right-turn aimed piston units 120 and 220. In this modification, ball 123 (or 223) is tightly received (or press-fitted) in cylindrical recess 122 (or 222) of piston body 121 (or 221).

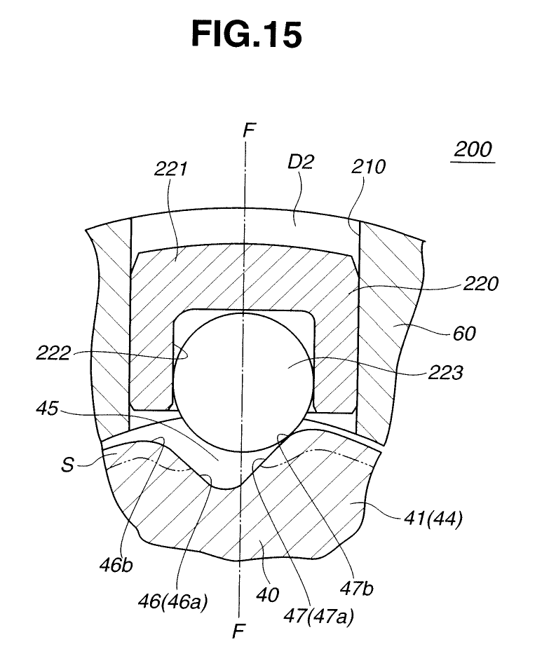

FIG. 15 is a view similar to FIG. 6, but showing a second embodiment of the present invention.

In this second embodiment, a left-turn aimed contact surface 46 and a right-turn aimed contact surface 47 are formed on input shaft 40 in a manner to face right-turn aimed piston unit 220 (or left-turn aimed piston unit 120). As shown, left-turn aimed contact surface 46 comprises a first inclined surface 46a that is flat and a second inclined surface 46b that is smoothly curved, and right-turn aimed contact surface 47 comprises a first inclined surface 47a that is flat and a second inclined surface 47b that is smoothly curved.

Also in this second embodiment, in the first open range “S1” of rotary switch valve 600 (see FIG. 9), the imaginary arm length “L” is smaller than that of the comparative example, and at the third open range “S3” of rotary switch valve 600, the imaginary arm length “L” shows a satisfied value. Thus, the automatic returning of motor vehicle to the original lane is also established in this second embodiment.

The entire contents of Japanese Patent Application 2007-172169 filed Jun. 29, 2007 are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A power steering device comprising:
an input shaft to which a steering wheel is connected;
an output shaft connected to the input shaft through a torsion bar;
a rotary switch valve arranged between the input and output shafts for selectively feeding a pressurized hydraulic fluid from a hydraulic pump to rightward-steering and leftward-steering assist chambers of a power cylinder in accordance with asteering relative rotation between the input and output shafts;
a right-turn aimed input shaft drive mechanism that applies the input shaft with a torque in a right-turn direction by using the pressurized hydraulic fluid from the hydraulic pump;
a left-turn aimed input shaft drive mechanism that applies the input shaft with a torque in a left-turn direction by using the pressurized hydraulic fluid from the hydraulic pump;
a detecting device that detects a current condition of at least one of a vehicle on which the power steering device is mounted, a driver who drives the vehicle and a road on which the vehicle runs; and
a liquid pressure control device that controls the pressure of the hydraulic fluid fed to the right-turn aimed and left-turn aimed input shaft drive mechanisms in accordance with the current condition detected by the detecting device,
wherein the liquid pressure control device controls the two input shaft drive mechanisms in such a manner that upon steering operation by the driver, the input shaft is applied with a counter torque in a direction against a steering direction of the input shaft, and upon receiving information signal from the detecting device, the input shaft is applied with a steering torque by a degree sufficient for practically actuating the rotary switch valve,
wherein each of the two input shaft drive mechanisms comprises a contact surface that is formed on an outer surface of the input shaft, and a piston unit that slides in a radially extending bore formed in the output shaft and is able to press against the contact surface with the aid of the hydraulic pressure from the hydraulic pump,
wherein the contact surface is inclined relative to a given path along which the piston unit travels, so that pressing the piston unit against the contact surface applies the input shaft with the torque; and
wherein an inclination angle of the contact surface relative to the given path changes at a portion where the piston unit changes a traveling direction.

2. A power steering device as claimed in claim 1, in which the contact surface comprises a first inclined surface against which the piston unit presses when the same moves toward the input shaft and a second inclined surface against which the piston unit presses when the same moves away from the input shaft, the inclination angle of the second inclined surface being greater than that of the first inclined surface, and in which when the rotary switch valve assumes a neutral position giving no torsion to the torsion bar, the piston unit of each input shaft drive mechanism is in contact with the first inclined surface.

3. A power steering device as claimed in claim 1, in which the contact surface comprises a first inclined surface against which the piston unit presses when the same moves toward the input shaft and a second inclined surface against which the piston unit presses when the same moves away from the input shaft, the inclination angle of the second inclined surface being greater than that of the first inclined surface, and in which when the rotary switch valve assumes a neutral position giving no torsion to the torsion bar, the piston unit of each input shaft drive mechanisms is in contact with a boundary portion between the first inclined surface and the second inclined surface.

4. A power steering device as claimed in claim 1, in which the contact surface comprises a first inclined surface against which the piston unit presses when the same moves toward the input shaft, a second inclined surface against which the piston unit presses when the same moves away from the input shaft, and a corner part that is formed at a boundary portion between the first inclined surface and the second inclined surface, the inclination angle of the second inclined surface being greater that that of the first inclined surface.

5. A power steering device as claimed in claim 1, in which the contact surface comprises a first inclined surface against which the piston unit presses when the same moves toward the input shaft, a second inclined surface against which the piston unit presses when the same moves away from the input shaft, and a chamfered flat surface that is formed at a boundary portion between the first inclined surface and the second inclined surface, the inclination angle of the second inclined surface being greater that that of the first inclined surface.

6. A power steering device as claimed in claim 1, in which the contact surface comprises a first inclined surface against which the piston unit presses when the same moves toward the input shaft, a second inclined surface against which the piston unit presses when the same moves away from the input shaft, and a chamfered round surface that is formed at a boundary portion between the first inclined surface and the second inclined surface, the inclination angle of the second inclined surface being greater that that of the first inclined surface.

7. A power steering device as claimed in claim 1, in which the rightward-steering assist chamber of the power cylinder is communicated with the left-turn aimed input shaft drive mechanism through the liquid pressure control device, and in which the leftward-steering assist chamber of the power cylinder is communicated with the right-turn aimed input shaft drive mechanism through the liquid pressure control device.

8. A power steering device as claimed in claim 1, in which the input shaft is made of a steel treated with a surface hardening process.

9. A power steering device as claimed in claim 1, in which the piston unit comprises:
a piston body having at an inside end thereof a cylindrical recess; and
a ball received in the cylindrical recess and contacting the contact surface of the input shaft, a diameter of the ball being smaller than a diameter of the cylindrical recess.

10. A power steering device as claimed in claim 1, in which the piston unit comprises:
a piston body having at an inside end thereof a cylindrical recess; and
a ball received in the cylindrical recess and contacting the contact surface of the input shaft, the ball being press-fitted to the cylindrical recess.

11. A power steering device as claimed in claim 9, in which the piston body has no portion that is in contact with the input shaft.

12. A power steering device comprising:
an input shaft to which a steering wheel is connected;
an output shaft connected to the input shaft through a torsion bar;
a rotary switch valve arranged between the input and output shafts for selectively feeding a pressurized hydraulic fluid from a hydraulic pump to rightward-steering and leftward-steering assist chambers of a power cylinder in accordance with a relative rotation between the input and output shafts;
a right-turn aimed input shaft drive mechanism that applies the input shaft with a torque in a right-turn direction by using the pressurized hydraulic fluid from the hydraulic pump;
a left-turn aimed input shaft drive mechanism that applies the input shaft with a torque in a left-turn direction by using the pressurized hydraulic fluid from the hydraulic pump;
a detecting device that detects a current condition of at least one of a vehicle on which the power steering device is mounted, a driver who drives the vehicle and a road on which the vehicle runs; and
a liquid pressure control device that controls the pressure of the hydraulic fluid fed to the right-turn aimed and left-turn aimed input shaft drive mechanisms in accordance with the current condition detected by the detecting device,
wherein the liquid pressure control device controls the two input shaft drive mechanisms in such a manner that upon steering operation by the driver, the input shaft is applied with a counter torque in a direction against a steering direction of the input shaft, and upon receiving information signal from the detecting device, the input shaft is applied with a steering torque by a degree sufficient for practically actuating the rotary switch valve,
wherein each of the two input shaft drive mechanisms comprises a contact surface that is formed on an outer surface of the input shaft, and a piston unit that slides in a radially extending bore formed in the output shaft and is able to press against the contact surface with the aid of the hydraulic pressure from the hydraulic pump,
wherein the contact surface is inclined relative to a given path along which the piston unit travels and comprises a first inclined surface and a second inclined surface whose inclination angle is greater than that of the first inclined surface, and
wherein when the piston unit presses against the second inclined surface, the input shaft is applied with the counter torque, and when the piston unit presses against the first inclined surface, the input shaft is applied with the steering torque.

13. A power steering device as claimed in claim 12, in which when the rotary switch valve assumes a neutral position giving no torsion to the torsion bar, the piston unit of each input shaft drive mechanism is in contact with the first inclined surface.

14. A power steering device as claimed in claim 12, in which when the rotary switch valve assumes a neutral position giving no torsion to the torsion bar, the piston unit of each input shaft drive mechanism is in contact with a boundary portion between the first inclined surface and the second inclined surface.

15. A power steering device as claimed in claim 12, in which the rightward-steering assist chamber of the power cylinder is communicated with the left-turn aimed input shaft drive mechanism through the liquid pressure control device, and in which the leftward-steering assist chamber of the power cylinder is communicated with the right-turn aimed input shaft drive mechanism through the liquid pressure control device.

16. A power steering device as claimed in claim 12, in which the input shaft is made of a steel treated with a surface hardening process.

17. A power steering device comprising:
an input shaft to which a steering wheel is connected;
an output shaft connected to the input shaft through a torsion bar;
a rotary switch valve arranged between the input and output shafts for selectively feeding a pressurized hydraulic fluid from a hydraulic pump to rightward-steering and leftward-steering assist chambers of a power cylinder in accordance with a relative rotation between the input and output shafts;
a right-turn aimed input shaft drive mechanism that applies the input shaft with a torque in a right-turn direction by using the pressurized hydraulic fluid from the hydraulic pump;
a left-turn aimed input shaft drive mechanism that applies the input shaft with a torque in a left-turn direction by using the pressurized hydraulic fluid from the hydraulic pump;
a detecting device that detects a current condition of at least one of a vehicle on which the power steering device is mounted, a driver who drives the vehicle and a road on which the vehicle runs; and
a liquid pressure control device that controls the pressure of the hydraulic fluid fed to the right-turn aimed and left-turn aimed input shaft drive mechanisms in accordance with the current condition detected by the detecting device,
wherein the liquid pressure control device controls the two input shaft drive mechanisms in such a manner that upon steering operation by the driver, the input shaft is applied with a counter torque in a direction against a steering direction of the input shaft, and upon receiving information signal from the detecting device, the input shaft is applied with a steering torque by a degree sufficient for practically actuating the rotary switch valve,
wherein each of the two input shaft drive mechanisms comprises a contact surface that is formed on an outer surface of the input shaft, and a piston unit that slides in a radially extending bore formed in the output shaft and is able to press against the contact surface with the aid of the hydraulic pressure from the hydraulic pump,
wherein the contact surface comprises a first inclined surface against which the piston unit presses when the same moves toward the input shaft and a second inclined surface against which the piston unit presses when the same moves away from the input shaft, the inclination angle of the second inclined surface being greater than that of the first inclined surface.

18. A power steering device as claimed in claim 17, in which when the rotary switch valve assumes a neutral position giving no torsion to the torsion bar, the piston unit of each input shaft drive mechanism is in contact with the first inclined surface.

19. A power steering device as claimed in claim 17, in which when the rotary switch valve assumes a neutral position giving no torsion to the torsion bar, the piston unit of each input shaft drive mechanism is in contact with a boundary portion between the first inclined surface and the second inclined surface.

20. A power steering device as claimed in claim 17, in which the input shaft is made of a steel treated with a surface hardening process.
